(19) United States
(12) Patent Application Publication
(10) Pub. No.: US 2009/0060503 A1
(43) Pub. Date: Mar. 5, 2009

(54) STORAGE OVER OPTICAL/WIRELESS INTEGRATED BROADBAND ACCESS NETWORK (SOBA) ARCHITECTURE

(75) Inventors: Si Yin, Kearny, NJ (US); Yuanqiu Luo, Hightstown, NJ (US); Lei Zong, Princeton, NJ (US); Stephen Rago, Warren, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/044,382

(22) Filed: Mar. 7, 2008

Related U.S. Application Data
(60) Provisional application No. 60/969,976, filed on Sep. 5, 2007.

(51) Int. Cl. H04J 14/00

(52) U.S. Cl. 398/48; 398/45

(57) ABSTRACT

An optical line terminal (OLT), network and method include input and output switching modules configured to switch between input and output channels. A transmission module is configured for physical layer transmission using at least one of a plurality of transmission technologies to provide multiple uses of an existing transmission line. A dynamic resource module is configured to allocate network resources dynamically to one or more storage area networks (SAN) based on storage resource requests. A service differentiation module is configured to determine and implement different service levels for SAN users. An existing network infrastructure is enabled to provide custom SAN services without a dedicated line and without interfering with existing services.

### RELATED APPLICATION INFORMATION

This application claims priority to provisional application Ser. No. 60/969,976 filed on Sep. 5, 2007, incorporated herein by reference.

The present application is related to U.S. application serial number (TBD), Attorney Docket Number 07034 (449-30), entitled “STORAGE AREA NETWORK EXTENSION OVER PASSIVE OPTICAL NETWORKS USING PARALLEL SIGNAL DETECTION”, filed (TBD) and incorporated herein by reference.

### BACKGROUND

1. Technical Field

The present invention relates to storage area networks and more particularly to storage access systems and methods for providing storage compatibilities over Optical/Wireless Integrated (OWI) broadband access (SOBA) architectures.

2. Description of the Related Art

The rapid growth of data-intensive applications, such as multimedia, e-business, e-learning, and Internet protocol television (IPTV), is driving the demand for higher data-storage capacity. Companies and organizations want their data to be stored in such a way that the large amount of data can be easily accessible and manageable. Furthermore, organizations also require critical data to be securely transported, stored, and consolidated at high speeds. Storage Area Networks (SANs) are emerging as the choice of data-storage technology because of their significant performance advantages, such as better scalability and higher availability, over the traditional storage architectures.

Referring to FIG. 1, a SAN 102 is a high-speed and special-purpose network that interconnects a set of storage devices 104 with associated servers 106 (e.g., UNIX, Windows NT, SUN, AIX). The SAN 102 targets to transfer data between computer systems (e.g., local area networks 108, clients 110) and storage elements 104, and among storage elements 104 (e.g., a disk array, tape library, tape, etc.).

Historically, primary and backup SAN islands are designed to operate within a limited distance, such as within a campus. After recent catastrophes that limited telecommunications and resulted in power grid failure, organizations realized that a SAN within a limited distance is insufficient to keep business continuity and provide data disaster recovery. To avoid severe damage from widespread power outages, earthquakes, fire, and terrorist attacks, the storage sites have to be physically separated up to hundreds or even thousands of miles, such that only one site will be affected in a disaster.

Federal regulators, such as the Office of Management and Budget (OMB) and the General Services Administration (GSA), have also adopted similar disaster recovery plans into a continuity of operations (COOP) plan, which is applicable to all federal agencies, airports, and financial institutes. SAN extension therefore has become a critical issue.

Existing SAN extensions are mainly about long-haul overlay. While several solutions have been proposed to extend SANs over long-haul networks, there are few addressing the bottleneck in the access network. The real-time and synchronous SAN extension requires gigabit-level data rate among storage devices. This high-bandwidth requirement challenges current telecommunications infrastructures in the access network. Gigabit-level bandwidth of storage service is far beyond the rate provided by the traditional technologies, such as DSL, Cable Modem, and E1/T1. The prohibitive cost of dedicated service over leased line or Fibre Channel (FC) limits its wide application in more companies.

Referring to FIG. 2, a dedicated channel 202 is required to connect a SAN 204 into a metro network 206, which will cost approximately $250,000 per year for leasing the channel (such as dark fiber) and maintaining the infrastructure. Therefore, an inexpensive, scalable, and high-transmission-rate technology/architecture is needed for storage service provisioning in the access network.

### SUMMARY

An optical line terminal (OLT), network and method include input and output switching modules configured to switch between input and output channels. A transmission module is configured for physical layer transmission using at least one of a plurality of transmission technologies to provide multiple uses of an existing transmission line. A dynamic resource module is configured to allocate network resources dynamically to one or more storage area networks (SAN) based on storage resource requests. A service differentiation module is configured to determine and implement different service levels for SAN users. The existing network infrastructure is enabled to provide custom SAN services without a dedicated line and without interfering with existing services.

An access network providing storage services includes an optical line terminal (OLT) configured to receive requests for storage services from at least one client and allocate resources based upon criteria. At least one storage area network (SAN) is configured to store information from the at least one client in accordance with a storage request, wherein the OLT, the SAN and the at least one client communicate over an existing network infrastructure using a multiplexing transmission technology to provide custom SAN services without a dedicated line and without interfering with existing network services.

A method for providing storage services on an Optical/Wireless Integrated (OWI) broadband access (SOBA) network includes receiving a request for storage services; dynamically allocating network resources to one or more storage area networks (SAN) based on storage resource requests; multiplexing information to be stored using at least one of a plurality of transmission technologies to provide multiple channels on existing network lines without a dedicated line and without interfering with existing services; and differentiating storage services based upon a client requesting the service to implement different service levels for SAN users.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a system diagram showing a storage area network (SAN) in accordance with the prior art;

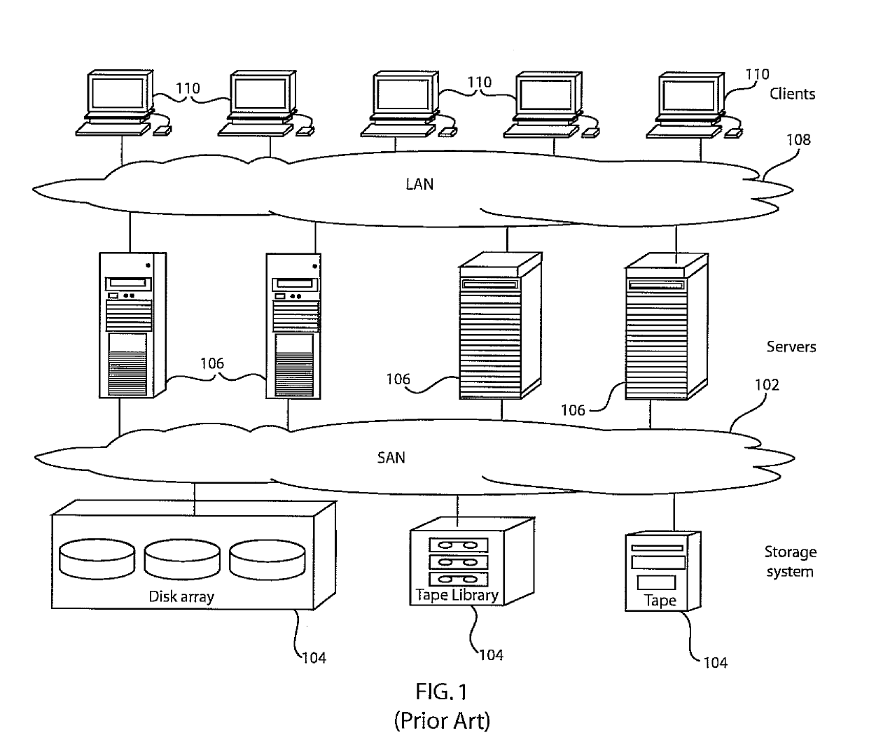

FIG. 2 is a system diagram showing a network extension for SAN services using a dedicated channel in accordance with the prior art;

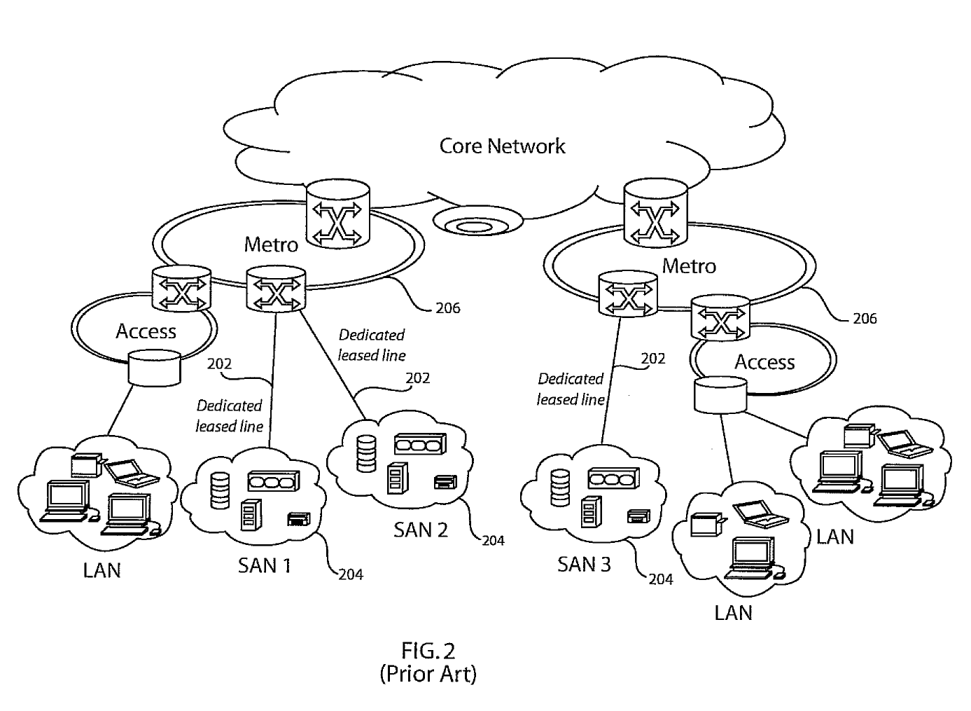

FIG. 3 is a system architecture for a SOBA network without dedicated channels in accordance with the present principles;

FIG. 4 is a block diagram showing a system architecture of a novel optical line terminal (OLT) in accordance with one embodiment;

FIG. 5 is a system diagram showing in-band transmission of storage information in accordance with one illustrative embodiment;

FIG. 6 is a system diagram showing out-of-band transmission of storage information in accordance with another illustrative embodiment;

FIG. 7 is a system diagram showing out-of-wavelength transmission of storage information in accordance with another illustrative embodiment; and

FIG. 8 is a system diagram showing the use of several transmission technologies in accordance with one illustrative embodiment.

### DETAILED DESCRIPTION OF PREFERRED EMBODIMENTS

The present principles provide a new architecture for storage area network (SAN) extension in an access network. The storage service is preferably provided over an Optical/Wireless Integrated (OWI) broadband access (SOBA) architecture. Conventional SAN extension encounters a dilemma: on one hand, an affordable access network (DSL, Cable, and T1/E1) has a bottleneck of only a Megabit-level transmission rate; and on the other hand, a high-speed, dedicated leased line, like fibre channel (FC), is cost-prohibitive.

In the present embodiments, SOBA architectures leverage a Passive Optical Network (PON) as well as wireless broadband access technology such as Worldwide Interoperability for Microwave Access (WiMAX) for high-speed and low-cost transmission. By using sub-carrier modulation (SCM) and wavelength division multiple access (WDMA), SOBA enables storage data transmission over the existing communication infrastructures without interfering with the current services. The present principles provide a new architecture, a storage service over an Optical/wireless Integrated (OWI) broadband access (SOBA) network, as a new approach for high-speed and low-cost SAN transmission in an access network.

Solutions in accordance with the present principles may include other networks and technologies as well. For example, optical-based solutions and IP-based solutions are contemplated. The optical-based solutions may include using storage area networks (SANs) over Synchronous Optical Network (SONET) and over wavelength Division Multiplexing (WDM) networks. WDM divides bandwidth on a fiber into several non-overlapping channels (wavelengths) and realizes simultaneous message transmission on different wavelengths in a core network.

IP-based solutions encapsulate data units of SAN traffic into standard IP frames to be transported over core networks. Several protocols, including Internet SCSI (iSCSI), fibre channel over TCP/IP (FCIP), and Internet fibre-channel protocol (iFCP) may be introduced to transport: the SCSI commands and responses, either by major vendors or the IP Storage Working Group of the Internet Engineering Task Force (IETF).

Embodiments described herein may be entirely hardware, entirely software or including both hardware and software elements. In a preferred embodiment, the present invention is implemented in hardware in an optical network including software elements. Software may include but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

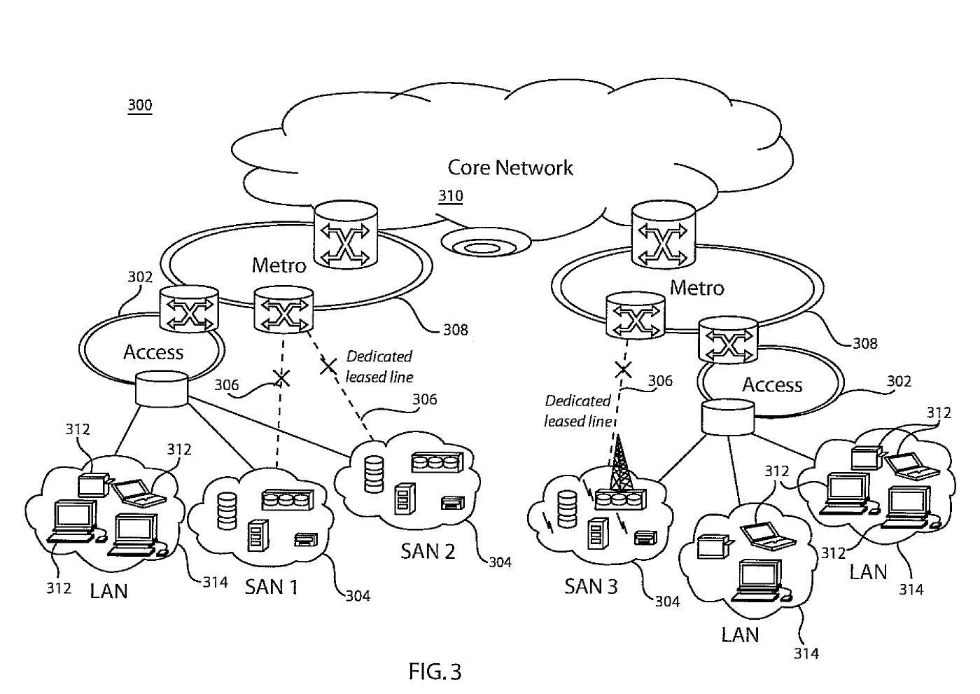

Referring now to the drawings in which like numerals represent the same or similar elements and initially to FIG. 3, a SOBA network 300 is illustratively shown which leverages an existing Passive Optical Access (PON) infrastructure in an access network 302, as well as a wireless broadband access technology, such as Worldwide Interoperability for Microwave Access (WiMAX). By employing the wireless part of an Optical/Wireless Integrated (OWI), SOBA enables SANs 304 (e.g., SAN 3) to take advantage of the flexibility offered by wireless transmission.

Instead of employing dedicated Fibre Channels (FC) 306 (indicated as crossed out dashed lines) to connect to a metro network 308, SOBA 300 employs the existing PON fibers to transmit the storage data. Consequently, SOBA 300 changes conventional point-to-point (P2P) storage network topology into a point-to-multiple-point (P2MP) storage network topology. In cases where SAN users have portable requirements, the wireless part of OWI provides mobile functionality. As a result, the SAN can be geographically extended through a core network 310 by taking advantage of the broadband optical and wireless access network infrastructure. This may include access networks 302, which provide access and storage services to clients or users 312 in local area networks 314 or other networks. This enables affordable storage services to small and medium enterprises.

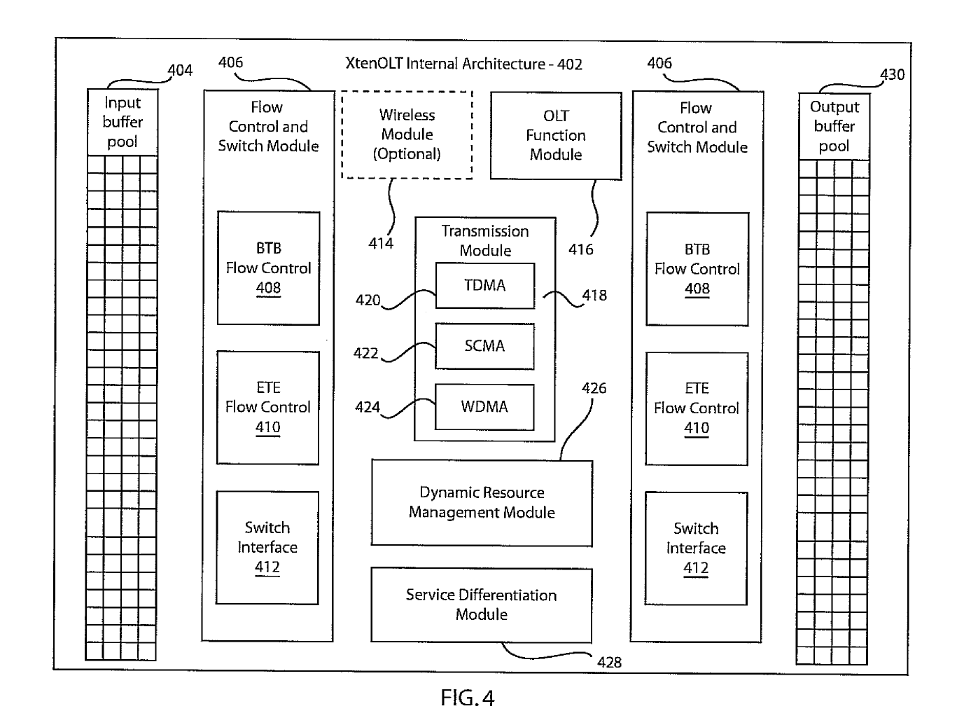

Referring to FIG. 4, an internal architecture of XtenOLT 402 is illustratively shown. XtenOLT 402 is a SOBA element which includes an enhanced optical line terminal (OLT) with storage service provisioning. An input buffer pool 404 is responsible for buffering incoming FC frames for further processing. A flow control and switch module 406 is composed of a buffer-to-buffer (BTB) flow control sub-module 408, an end-to-end (ETE) flow control sub-module 410, and a switch interface 412. The flow control and switch module 406 controls switching operations into and out of the XtenOLT 402.

An optional wireless module 414 permits the sending and receiving of wireless signals. In this regard, the XtenOLT 402 may be wirelessly accessed. The SAN devices may be portable through the use of a wireless interface to the XtenOLT. An OLT functional module 416 provides the conventional operations and tasks that are normally provided by an OLT device.

In addition to the optional wireless module 414 and the OLT functional module 416, three core modules are introduced in XtenOLT 402, namely, a transmission module 418, dynamic resource allocation (DRA) module 426, and service differentiation (SD) module 428, respectively.

The transmission module 418 is responsible for physical layer transmission, through Time Division Multiple Access (TDMA) 420, Sub-Carrier Multiple Access (SCMA) 422 or Wavelength Division Multiple Access (WDMA) 424. Each transmission technology may be selected based upon the type of signal being received or in accordance with the DRA module 426. Note that the transmission technology also can be selected based on the service differentiation module.

The DRA module 426 is responsible for dynamically allocating network resources to each SAN that has resource requests. The DRA 426 may include a plurality of rules and or sense a plurality of conditions to make decisions on which resources to employ and how to employ them. For example, the rules may be based on the type of hardware requesting service, the entity requesting service, any service agreements, etc. The DRA 426 may receive input from transmission module 418 and/or the SD module 428.

The SD module 428 is used to determine the different service levels for SAN users, and act accordingly to guarantee Service Level Agreements (SLAs). An output buffer pool 430 is employed for buffering the aggregated FC frames from individual SAN users before their departure from OLT 402.

Transmission technologies for storage data transmission in SOBA: three transmission options are taken into consideration for illustrative purposes, namely, in-band transmission, out-of-band transmission, and out-of-wavelength transmission.

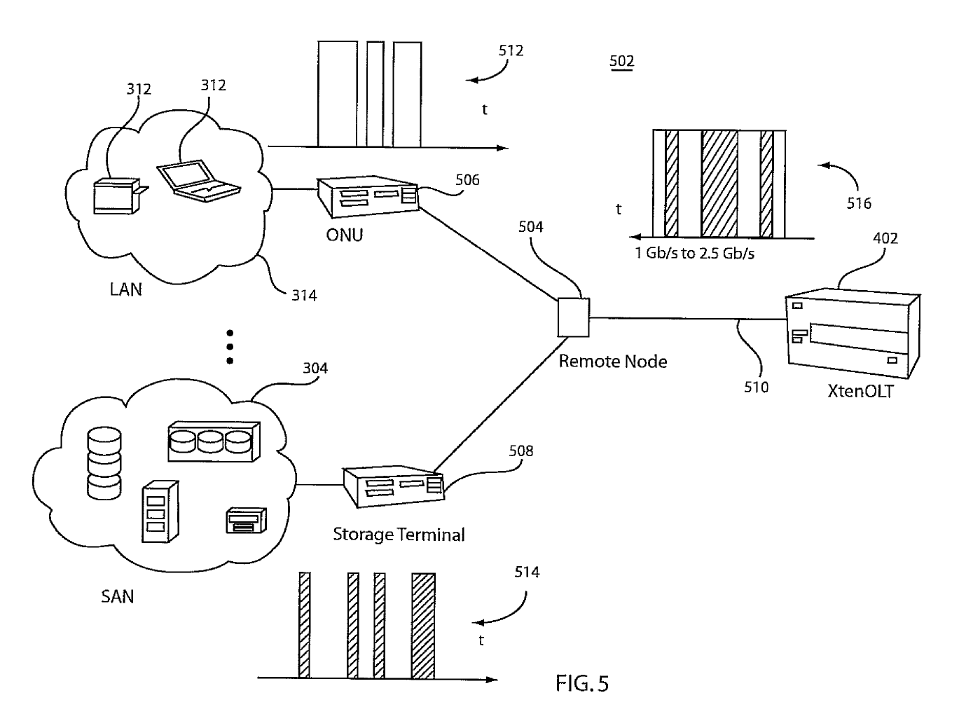

Referring to FIG. 5, a portion of a network 502 is shown to demonstrate in-band transmission. For the in-band transmission, a SAN 304 shares an upstream channel 510 with other optical network units (ONUS) 506 through a Time Division Multiple Access (TDMA) technology as depicted in graphs 512, 514 and 516. A remote node 504 may provide a location where ONUs 506 and a storage terminal 50B connect to share the channel 510. SAN 304 is allocated a portion of a transmission window statically or dynamically in each service cycle as shown in graph 514. Since a traditional PON provides a transmission rate from several tens of megabits per second to a few gigabits per second at low cost, SOBA enables the SAN 304 to reach its synchronous and high-speed objective at affordable cost.

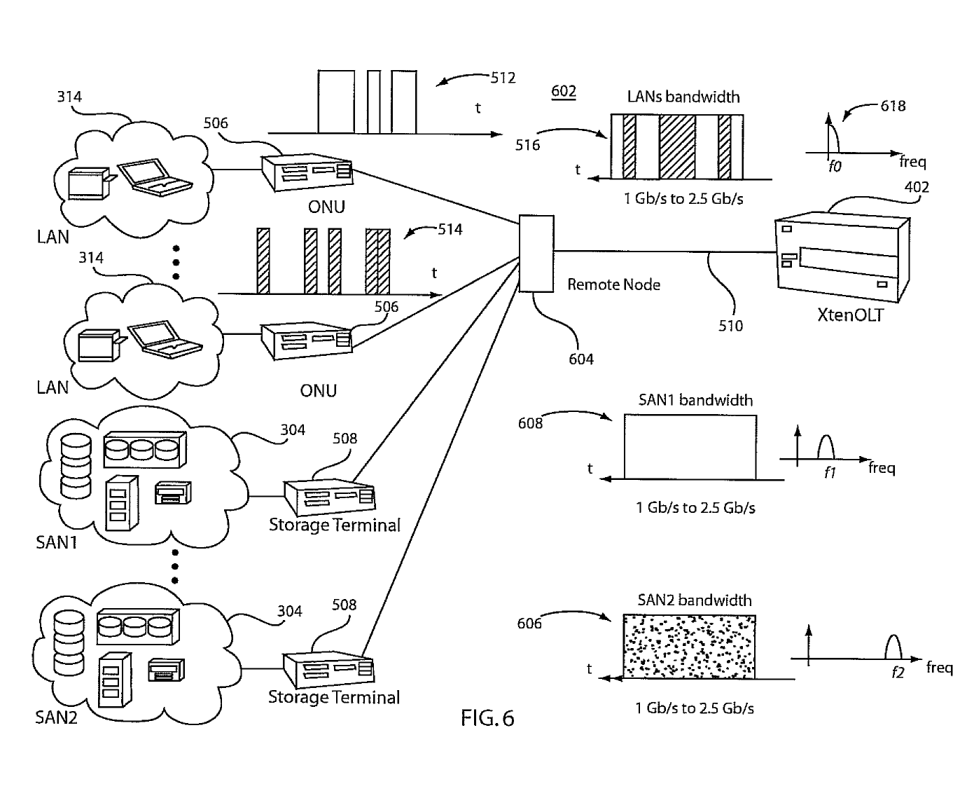

Referring to FIG. 6, out-of-band transmission is demonstratively shown on a portion of a network 602. For the more important SAN applications that rely on a gigabit-level transmission rate, SOBA fulfills the bandwidth requirements with an out-of-band transmission technology. This is facilitated by the sub-carrier multiple access (SCMA) technology depicted in graphs 606, 608 and 516.

The base band f0 (618) is used to transmit the data traffic from LANs 314, while two sub-band frequencies, f1 (608) and f2 (606), are utilized to transmit the storage data from SAN 1 304 and SAN 2 304, respectively. Either SAN 304 transmits up to, e.g., 2.5 Gbps by using the allocated sub-band frequencies through the existing communication infrastructure. A plurality of storage terminals 508 and/or ONUs 506 may employ separate frequency bands for SCMA technology transmissions and share a single existing channel 510.

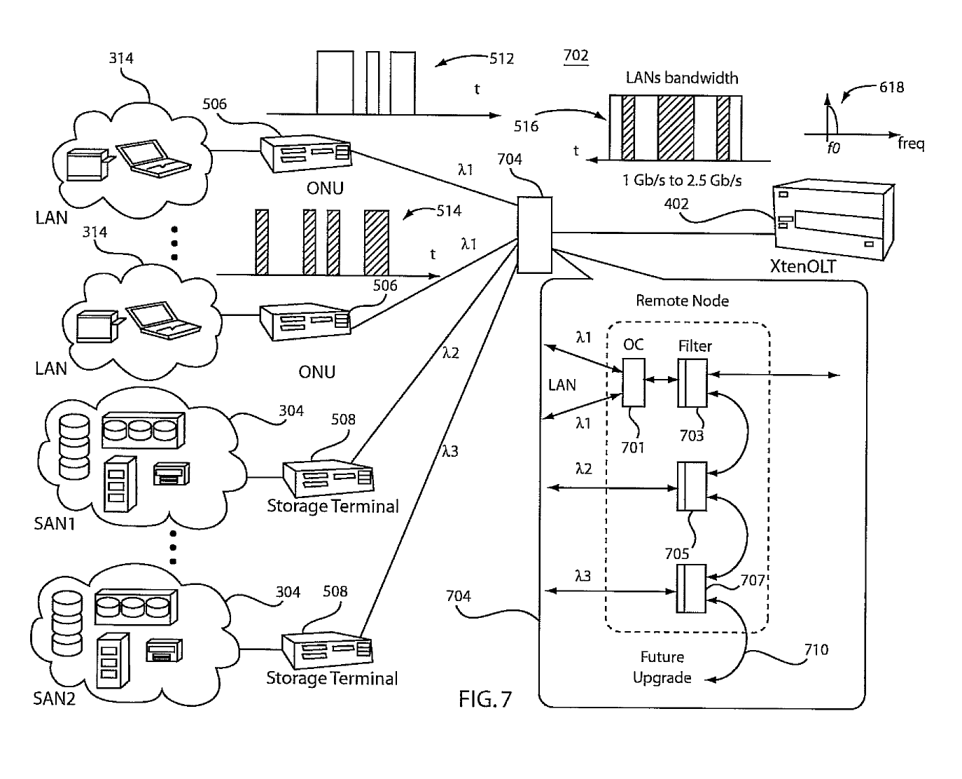

Referring to FIG. 7, an out-of-wavelength transmission is demonstratively shown on a portion of a network 702. For the most critical storage data transmission with a multi-gigabit transmission rate requirement, an out-of-wavelength technology is preferably employed. This practical method takes advantage of Wavelength Division Multiple Access (WDMA). LANs 314 are assigned wavelength λ1 for data transmission, and SAN 1 304 and SAN 2 304 are assigned another two wavelengths λ2 and λ3, respectively, for storage data transmission. A remote node 704 is responsible for wavelength multiplexing in the upstream transmission and demultiplexing in the downstream delivery.

Remote node 704 may include optical couplers OC 701 to couple signals of the same wavelength together. Remote node 704 includes filters 703, 705, and 707 which are employed to remove all but the desired wavelengths from a signal. Remote node 704 may be configured to handle any number of different wavelengths (e.g., include provisions for future upgrades 710).

Case study: a case study is provided to show how SOBA may be utilized in accordance with the present principles.

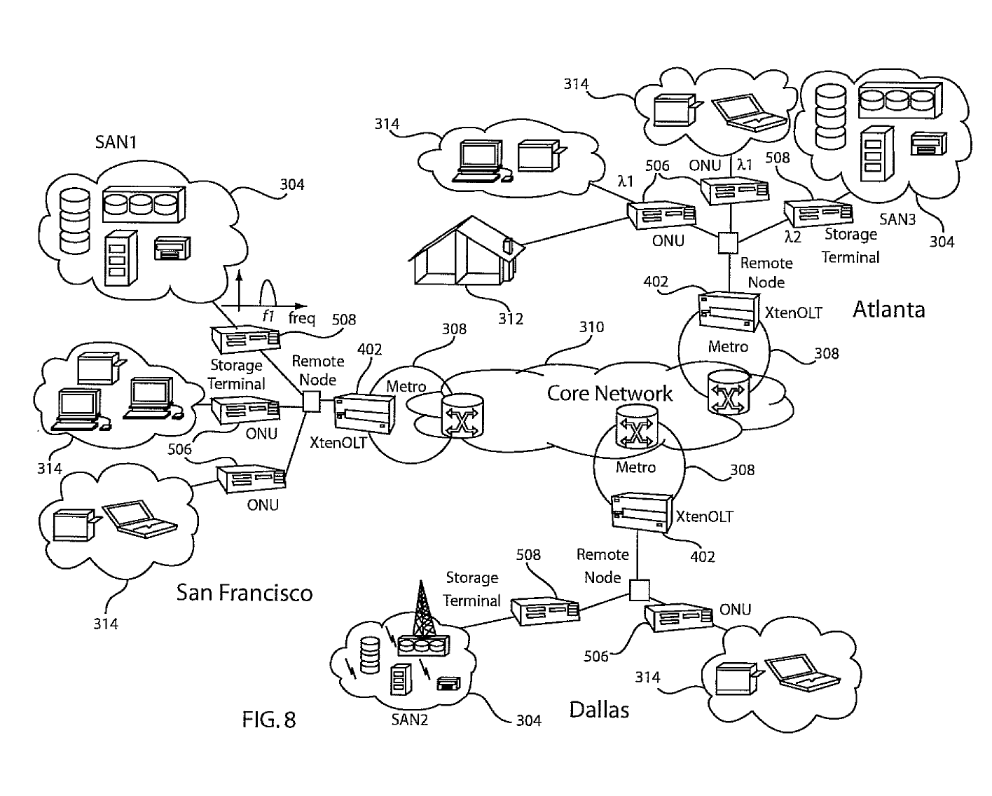

Referring to FIG. 8, an exemplified SOBA deployment is depicted. SAN1 304 and SAN2 304 are the two primary sites at San Francisco and Dallas, respectively, while SAN3 304 is a storage center in Atlanta for routine backup and disaster recovery. SOBA enables the provisioning of a storage service nationwide even with a separation between the primary site and the backup center by hundreds of miles. Different transmission technologies are employed in FIG. B. For example, storage data of SAN1 304 are modulated by sub-carrier signals to XtenOLT 402. TDMA is utilized at SAN 2 304. SAN 3 304 is allocated one dedicated wavelength λ2 for storage data transmission. Since SAN2 304 has a portability requirement, wireless access technology is utilized. The added SANs do not affect the existing infrastructure and service at the sites in Dallas, San Francisco, and Atlanta.

By using the SOBA architecture, the SAN 304 users can greatly enhance their Return on Investment (ROI) by largely reducing the cost for SAN deployment while maintaining a similar SAN service level compared to the dedicated fiber channel case. Table 1 shows an approximate comparison of SOBA and a dedicated Fiber Channel for illustration purposes.

TABLE 1
Comparison of Dedicated Fiber Channel and SOBA:

| | | Transmission |
|---|---|---|
| Architecture | Price | rate |
| Dedicated fiber | $241,967 per | Up to 4 Gbps |
| channel | year | |
| SOBA with FiOS | $36,000 per | 2.5 Gbps or |
| | year | greater |

From the comparison in Table 1, it is clear that the shared infrastructure of a PON can significantly reduce the overall cost per gigabit from dedicated channels in conventional dedicated fiber channel systems. With the present SOBA topology, the new element (XtenOLT) 402, and plurality of transmission technologies, SOBA provides a high data rate up to several tens of gigabits per second for SAN applications. Consequently, the traditional SAN user is able to enhance the ROI of their investment in storage services by using SOBA.

A new network architecture provides storage over an optical-wireless-integrated broadband access network, to address synchronous and high-speed storage data transmission in an access network. SOBA leverages existing PON infrastructure as well as the wireless broadband access technology such as WiMAX. By extending storage service over a long-haul network, SOBA enables storage data transmission on the existing communication infrastructures without interfering with the current access services.

Having described preferred embodiments for systems and methods for storage over an optical/wireless integrated broadband access network (SOBA) architecture (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An optical line terminal (OLT), comprising;
input and output switching modules configured to switch between input and output channels;
a transmission module configured for physical layer transmission using at least one of a plurality of transmission technologies to provide multiple uses of an existing transmission line;
a dynamic resource module configured to allocate network resources dynamically to one or more storage area networks (SAN) based on storage resource requests; and
a service differentiation module configured to determine and implement different service levels for SAN users, wherein an existing network infrastructure is enabled to provide custom SAN services without a dedicated line and without interfering with existing services.

2. The OLT as recited in claim 1, wherein the plurality of transmission technologies includes at least one of Time Division Multiple Access (TDMA), Sub-Carrier Multiple Access (SCMA) and Wavelength Division Multiple Access (WDMA).

3. The OLT as recited in claim 1, wherein the network infrastructure includes an optical network, a wireless network or both.

4. The OLT as recited in claim 1, wherein the OLT is in an Optical/Wireless Integrated (OWI) broadband access (SOBA) network and the storage service is provided on the SOBA network.

5. The OLT as recited in claim 1, wherein the service differentiation module determines and implements different service levels based upon service level agreements.

6. An access network providing storage services, comprising:
an optical line terminal (OLT) configured to receive requests for storage services from at least one client and allocate resources based upon criteria;
at least one storage area network (SAN) configured to store information from the at least one client in accordance with a storage request, wherein the OLT, the SAN and the at least one client communicate over existing network infrastructure using a multiplexing transmission technology to provide custom SAN services without a dedicated line and without interfering with existing network services.

7. The access network as recited in claim 6, wherein the transmission technology includes at least one of Time Division Multiple Access (TDMA), Sub-Carrier Multiple Access (SCMA) and Wavelength Division Multiple Access (WDMA).

8. The access network as recited in claim 6, wherein the network infrastructure includes an optical network, a wireless network or both.

9. The access network as recited in claim 6, wherein the access network is an Optical/Wireless Integrated (OWI) broadband access (SOBA) network.

10. The access network as recited in claim 6, wherein the OLT determines and implements different service levels based upon service level agreements.

11. The access network as recited in claim 6, wherein the at least one client includes one or more local area networks each with an optical network unit (ONU) access point, wherein each ONU communications at a different wavelength.

12. The access network as recited in claim 6, wherein the at least one client includes one or more local area networks each with an optical network unit (ONU) access point, wherein each ONU communications with a different sub-carrier.

13. The access network as recited in claim 6, wherein the at least one client includes one or more local area networks each with an optical network unit (ONU) access point, wherein each ONU communications at a different designated time slot.

14. The access network as recited in claim 6, further comprising a remote node for wavelength multiplexing and demultiplexing between the at least one client, the OLT and the SAN.

15. A method for providing storage services on an Optical/wireless Integrated (OWI) broadband access (SOBA) network, comprising:
receiving a request for storage services;
dynamically allocating network resources to one or more storage area networks (SAN) based on storage resource requests;
multiplexing information to be stored using at least one of a plurality of transmission technologies to provide multiple channels on existing network lines without a dedicated line and without interfering with existing services; and
differentiating storage services based upon a client requesting the service to implement different service levels for SAN users.

16. The method as recited in claim 15, wherein multiplexing includes using at least one of Time Division Multiple Access (TDMA), Sub-Carrier Multiple Access (SCMA) and Wavelength Division Multiple Access (WDMA).

17. The method as recited in claim 15, wherein differentiating storage services includes differentiating services based upon service level agreements.

18. The method as recited in claim 15, wherein the transmission technologies for storage data transmission include at least one of in-band transmission, out-of-band transmission, and out-of-wavelength transmission.
